(19) United States
(12) Patent Application Publication
(10) Pub. No.: US 2004/0093996 A1
(43) Pub. Date: May 20, 2004

(54) Ratchet socket that can be operated conveniently

(76) Inventor: Pao-Chu Fu, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/643,293

(22) Filed: Aug. 19, 2003

(30) Foreign Application Priority Data
Nov. 14, 2002 (TW) 091218286

(51) Int. Cl. B25B 13/06

(52) U.S. Cl. 81/121.1

(57) ABSTRACT

A ratchet socket includes a socket body having an end formed with a mounting hole. The mounting hole has an inner wall formed with twelve resting protrusions and twelve chambers located between the twelve resting protrusions. Thus, by provision of the twelve resting protrusions and the twelve chambers of the ratchet socket, the ratchet socket can be used to operate a special screw, such as the gear-shaped screw, the ratchet screw, the star-shaped screw or the like, thereby greatly enhancing the versatility of the ratchet socket.

### BACKGROUND OF THE INVENTION

1. Field of the Invention

The present invention relates to a ratchet socket, and more particularly to a ratchet socket that can be operated easily and conveniently.

2. Description of the Related Art

A conventional socket can be used to operate a common screw (or nut), such as the tetragonal screw, the hexagonal screw, the octagonal screw, the dodecagonal screw or the like. However, the conventional socket cannot be used to operate a special screw (or nut), such as the gear-shaped screw, the ratchet screw, the star-shaped screw or the like, thereby limiting the versatility of the conventional socket. In addition, the screw (or nut) often includes two specifications, that is, the metric system and the British system. However, the conventional socket can only be used to operate the metric screw or the British screw, thereby limiting the versatility of the conventional socket.

### SUMMARY OF THE INVENTION

The primary objective of the present invention is to provide a ratchet socket that can be operated easily and conveniently.

Another objective of the present invention is to provide a ratchet socket, wherein by provision of the twelve resting protrusions and the twelve chambers of the ratchet socket, the ratchet socket can be used to operate a special screw, such as the gear-shaped screw, the ratchet screw, the star-shaped screw or the like, thereby enhancing the versatility of the ratchet socket.

A further objective of the present invention is to provide a ratchet socket, wherein by provision of the twelve resting protrusions and the twelve chambers of the ratchet socket, the ratchet socket can also be used to operate a common screw, such as the metric screw, the British screw, the tetragonal screw, the octagonal screw, the dodecagonal screw or the like, thereby enhancing the versatility of the ratchet socket.

A further objective of the present invention is to provide a ratchet socket, wherein each of the twelve resting protrusions has an outer end formed with an inclined surface, thereby facilitating alignment of the ratchet socket with the screw or the nut.

In accordance with the present invention, there is provided a ratchet socket, comprising:

a socket body having an end formed with a mounting hole;

the mounting hole having an inner wall formed with twelve resting protrusions and twelve chambers located between the resting protrusions.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away cross-sectional view of a ratchet socket in accordance with the preferred embodiment of the present invention;

FIG. 2 is a top plan view of the ratchet socket in accordance with the preferred embodiment of the present invention;

FIG. 3 is an exploded perspective view of the ratchet socket and a gear-shaped screw in accordance with the preferred embodiment of the present invention;

FIG. 4 is a top plan cross-sectional assembly view of the ratchet socket and the gear-shaped screw as shown in FIG. 3;

FIG. 5 is an exploded perspective view of the ratchet socket and a ratchet screw in accordance with the preferred embodiment of the present invention;

FIG. 6 is a top plan cross-sectional assembly view of the ratchet socket and the ratchet screw as shown in FIG. 5;

FIG. 7 is an exploded perspective view of the ratchet socket and a star-shaped screw in accordance with the preferred embodiment of the present invention;

FIG. 8 is a top plan cross-sectional assembly view of the ratchet socket and the star-shaped screw as shown in FIG. 7;

FIG. 9 is an exploded perspective view of the ratchet socket and a metric screw in accordance with the preferred embodiment of the present invention;

FIG. 10 is a top plan cross-sectional assembly view of the ratchet socket and the metric screw as shown in FIG. 9;

FIG. 11 is a top plan cross-sectional assembly view of the ratchet socket and a British screw in accordance with the preferred embodiment of the present invention;

FIG. 12 is a top plan cross-sectional assembly view of the ratchet socket and a tetragonal screw in accordance with the preferred embodiment of the present invention;

FIG. 13 is a top plan cross-sectional assembly view of the ratchet socket and an octagonal screw in accordance with the preferred embodiment of the present invention; and

FIG. 14 is a top plan cross-sectional assembly view of the ratchet socket and a dodecagonal screw in accordance with the preferred embodiment of the present invention.

### DETAILED DESCRIPTION OF THE INVENTION

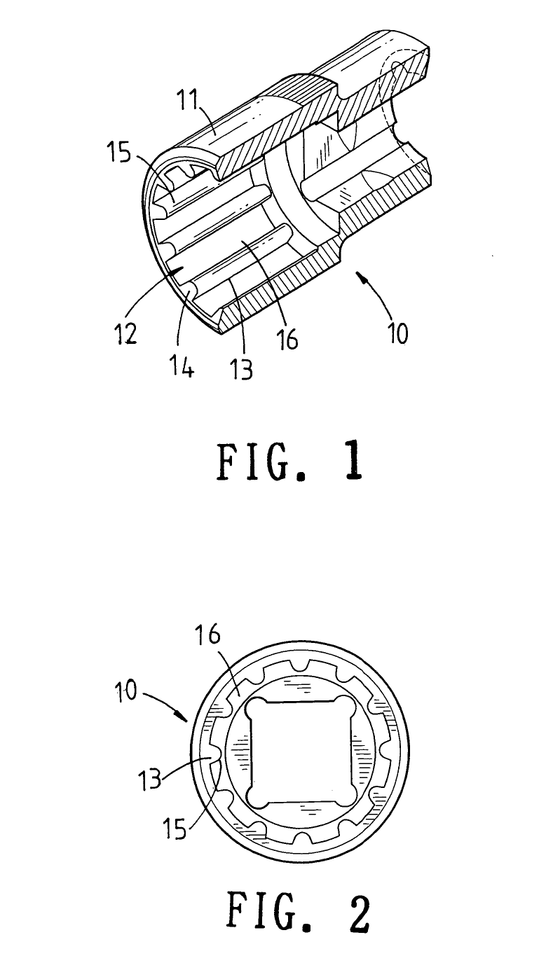

Referring to the drawings and initially to FIGS. 1 and 2, a ratchet socket 10 in accordance with the preferred embodiment of the present invention comprises a socket body 11 having an end formed with a mounting hole 12. The mounting hole 12 has an inner wall formed with twelve resting protrusions 13 and twelve chambers 16 located between the twelve resting protrusions 13. Preferably, the twelve resting protrusions 13 are arranged in an annular manner and are equally spaced from each other. In addition, each of the twelve resting protrusions 13 has an outer end formed with an inclined surface 14. In addition, each of the twelve resting protrusions 13 has a side end formed with a resting face 15. Preferably, the resting face 15 of each of the twelve resting protrusions 13 has an arcuate shape.

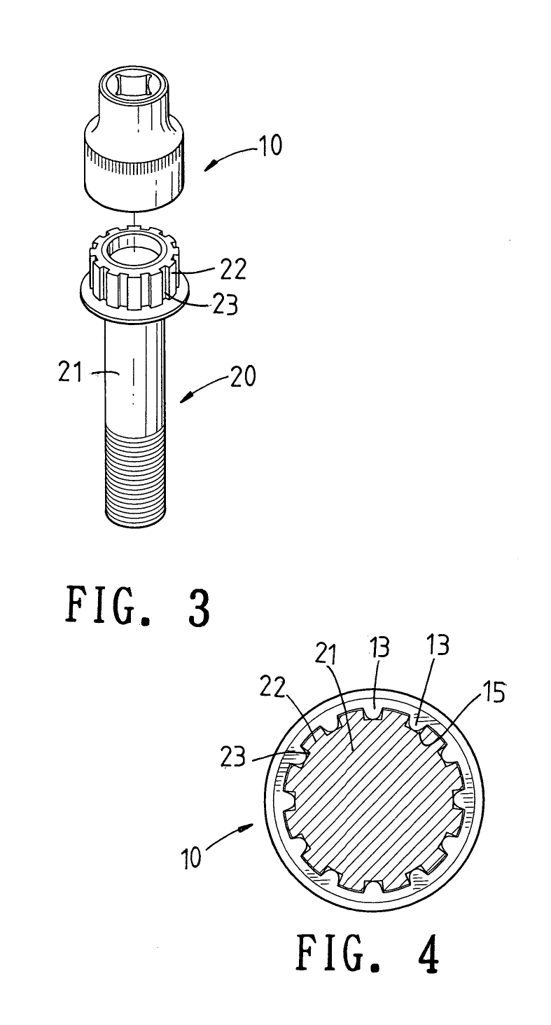

Referring to FIGS. 3 and 4, the ratchet socket 10 is used to operate a gear-shaped screw 20. The gear-shaped screw 20 includes a main body 21 having an outer wall formed with twelve toothed portions 22 and twelve receiving recesses 23 located between the twelve toothed portions 22.

In operation, when the ratchet socket 10 is mounted on the gear-shaped screw 20, each of the twelve resting protrusions 13 of the ratchet socket 10 is received in a respective one of the twelve receiving recesses 23 of the gear-shaped screw 20, and the resting face 15 of each of the twelve resting protrusions 13 of the ratchet socket 10 is rested on a side of a respective one of the twelve toothed portions 22 of the gear-shaped screw 20, so that the ratchet socket 10 is combined with the gear-shaped screw 20 rigidly and stably, so as to drive and rotate the gear-shaped screw 20.

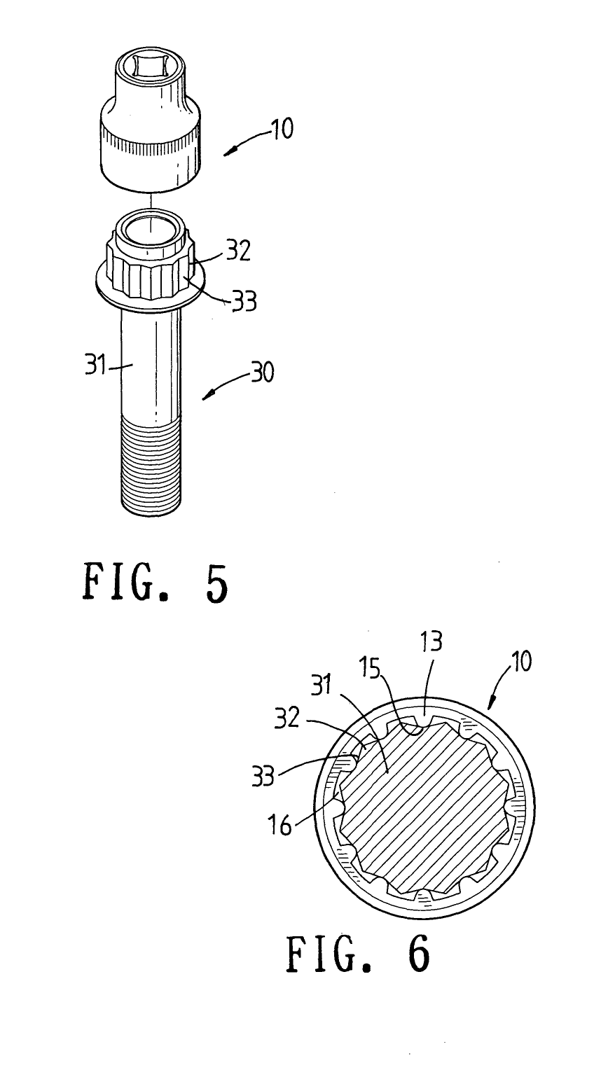

Referring to FIGS. 5 and 6, the ratchet socket 10 is used to operate a ratchet screw 30. The ratchet screw 30 includes a main body 31 having an outer wall formed with twelve ratchet teeth 32 and twelve urging faces 33 located between the twelve ratchet teeth 32.

In operation, when the ratchet socket 10 is mounted on the ratchet screw 30, the resting face 15 of each of the twelve resting protrusions 13 of the ratchet socket 10 is rested on a respective one of the twelve urging faces 33 of the ratchet screw 30, and each of the twelve ratchet teeth 32 of the ratchet screw 30 is received in a respective one of the twelve chambers 16 of the ratchet socket 10, so that the ratchet socket 10 is combined with the ratchet screw 30 rigidly and stably, so as to drive and rotate the ratchet screw 30.

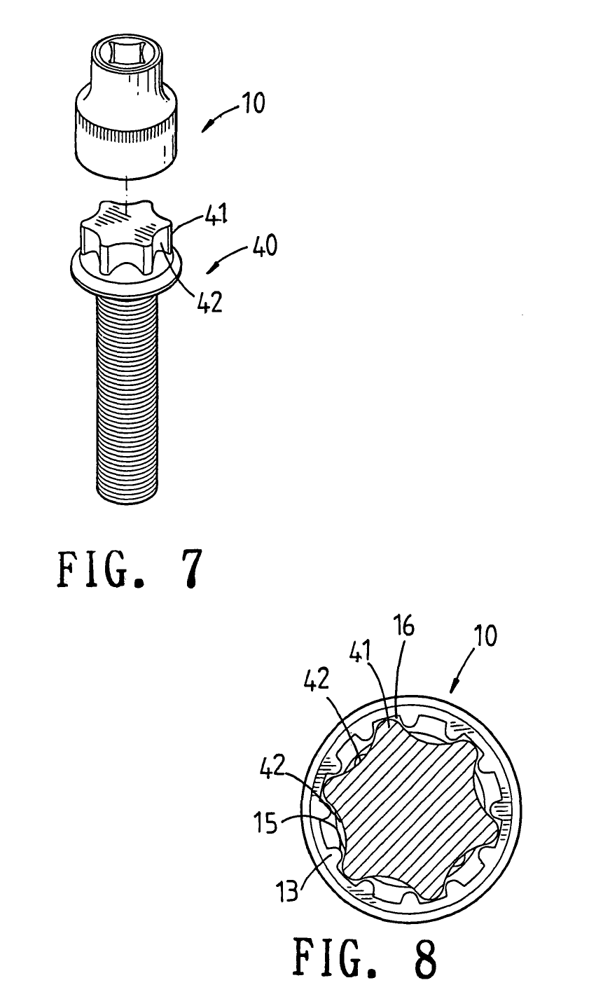

Referring to FIGS. 7 and 8, the ratchet socket 10 is used to operate a star-shaped screw 40. The star-shaped screw 40 includes a main body having an outer wall formed with six chamfers 41 and six arcuate faces 42 located between the six chamfers 41.

In operation, when the ratchet socket 10 is mounted on the star-shaped screw 40, the resting face 15 of each of the twelve resting protrusions 13 of the ratchet socket 10 is rested on a respective one of the six arcuate faces 42 of the star-shaped screw 40, and each of the six chamfers 41 of the star-shaped screw 40 is received in a respective one of the twelve chambers 16 of the ratchet socket 10, so that the ratchet socket 10 is combined with the star-shaped screw 40 rigidly and stably, so as to drive and rotate the star-shaped screw 40.

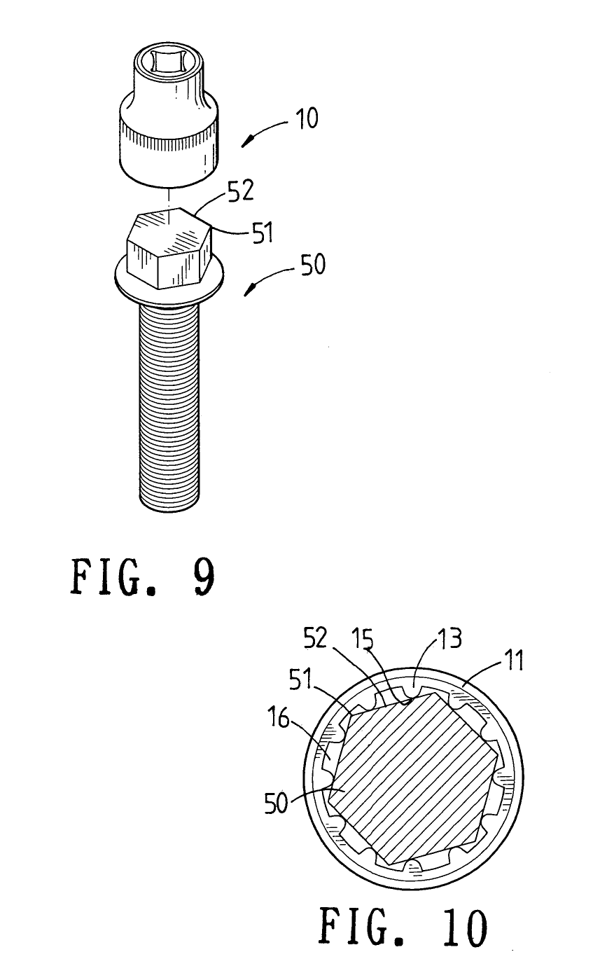

Referring to FIGS. 9 and 10, the ratchet socket 10 is used to operate a metric screw 50. The metric screw 50 includes a main body having an outer wall formed with six side faces 52 and six corners 51.

In operation, when the ratchet socket 10 is mounted on the metric screw 50, the resting face 15 of each of the twelve resting protrusions 13 of the ratchet socket 10 is rested on a respective one of the six side faces 52 of the metric screw 50, and each of the six corners 51 of the metric screw 50 is received in a respective one of the twelve chambers 16 of the ratchet socket 10, so that the ratchet socket 10 is combined with the metric screw 50 rigidly and stably, so as to drive and rotate the metric screw 50.

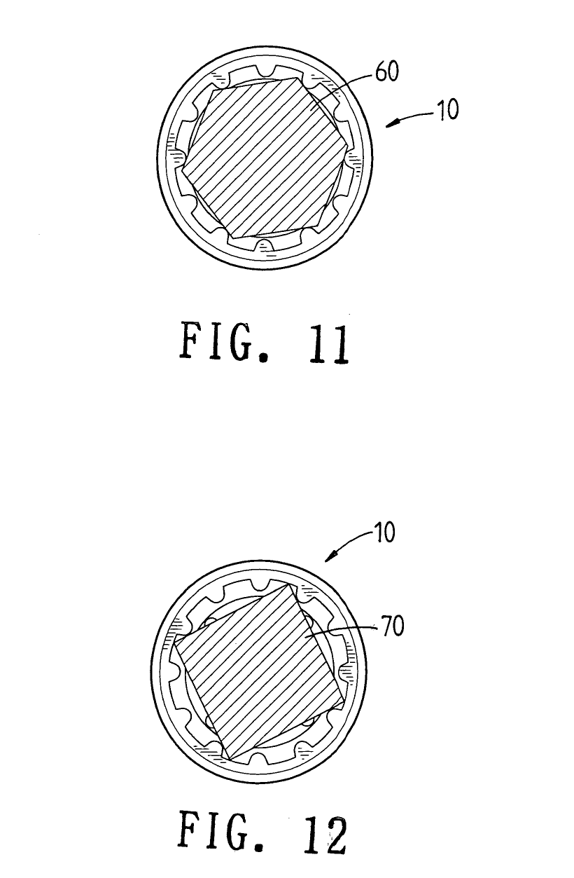

Referring to FIG. 11, the ratchet socket 10 is used to operate a British screw 60 in a similar manner.

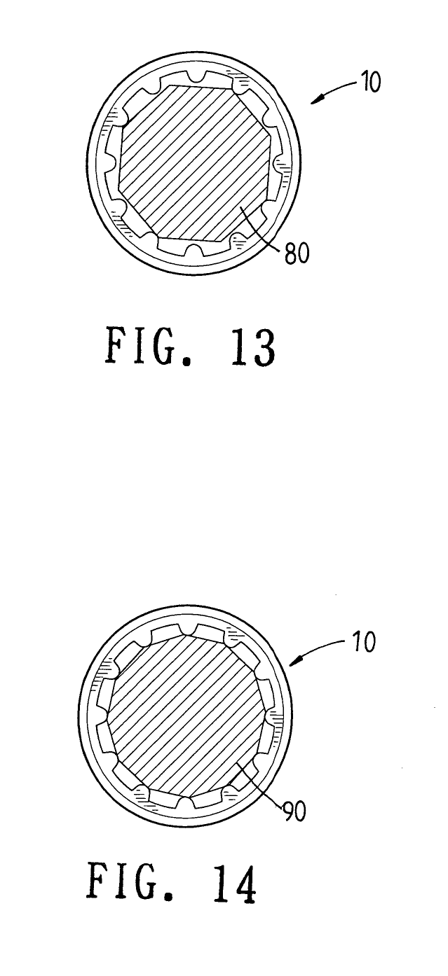

Referring to FIG. 12, the ratchet socket 10 is used to operate a tetragonal screw 70 in a similar manner. Referring to FIG. 13, the ratchet socket 10 is used to operate an octagonal screw 80 in a similar manner.

Referring to FIG. 14, the ratchet socket 10 is used to operate a dodecagonal screw 90 in a similar manner.

Accordingly, by provision of the twelve resting protrusions 13 and the twelve chambers 16 of the ratchet socket 10, the ratchet socket 10 can be used to operate a special screw, such as the gear-shaped screw 20, the ratchet screw 30, the star-shaped screw 40 or the like, thereby enhancing the versatility of the ratchet socket 10. In addition, by provision of the twelve resting protrusions 13 and the twelve chambers 16 of the ratchet socket 10, the ratchet socket 10 can also be used to operate a common screw, such as the metric screw 50, the British screw 60, the tetragonal screw 70, the octagonal screw 80, the dodecagonal screw 90 or the like, thereby enhancing the versatility of the ratchet socket 10. Further, each of the twelve resting protrusions 13 has an outer end formed with an inclined surface 14, thereby facilitating alignment of the ratchet socket 10 with the screw or the nut.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A ratchet socket, comprising:
a socket body having an end formed with a mounting hole;
the mounting hole having an inner wall formed with twelve resting protrusions and twelve chambers located between the resting protrusions.

2. The ratchet socket in accordance with claim 1, wherein the twelve resting protrusions are arranged in an annular manner.

3. The ratchet socket in accordance with claim 1, wherein the twelve resting protrusions are equally spaced from each other.

4. The ratchet socket in accordance with claim 1, wherein each of the twelve resting protrusions has an outer end formed with an inclined surface.

5. The ratchet socket in accordance with claim 1, wherein each of the twelve resting protrusions has a side end formed with a resting face.

6. The ratchet socket in accordance with claim 5, wherein the resting face of each of the twelve resting protrusions has an arcuate shape.

7. The ratchet socket in accordance with claim 1, wherein the ratchet socket is used to operate a gear-shaped screw.

8. The ratchet socket in accordance with claim 7, wherein the gear-shaped screw includes a main body having an outer wall formed with twelve toothed portions and twelve receiving recesses located between the twelve toothed portions, each of the twelve resting protrusions of the ratchet socket is received in a respective one of the twelve receiving recesses of the gear-shaped screw, and the resting face of each of the twelve resting protrusions of the ratchet socket is rested on a side of a respective one of the twelve toothed portions of the gear-shaped screw, so that the ratchet socket is combined with the gear-shaped screw.

9. The ratchet socket in accordance with claim 1, wherein the ratchet socket is used to operate a ratchet screw.

10. The ratchet socket in accordance with claim 9, wherein the ratchet screw includes a main body having an outer wall formed with twelve ratchet teeth and twelve urging faces located between the twelve ratchet teeth, the resting face of each of the twelve resting protrusions of the ratchet socket is rested on a respective one of the twelve urging faces of the ratchet screw, and each of the twelve ratchet teeth of the ratchet screw is received in a respective one of the twelve chambers of the ratchet socket, so that the ratchet socket is combined with the ratchet screw.

11. The ratchet socket in accordance with claim 1, wherein the ratchet socket is used to operate a star-shaped screw.

12. The ratchet socket in accordance with claim 11, wherein the star-shaped screw includes a main body having an outer wall formed with six chamfers and six arcuate faces located between the six chamfers, the resting face of each of the twelve resting protrusions of the ratchet socket is rested on a respective one of the six arcuate faces of the star-shaped screw, and each of the six chamfers of the star-shaped screw is received in a respective one of the twelve chambers of the ratchet socket, so that the ratchet socket is combined with the star-shaped screw.

13. The ratchet socket in accordance with claim 1, wherein the ratchet socket is used to operate a metric screw.

14. The ratchet socket in accordance with claim 13, wherein the metric screw includes a main body having an outer wall formed with six side faces and six corners, the resting face of each of the twelve resting protrusions of the ratchet socket is rested on a respective one of the six side faces of the metric screw, and each of the six corners of the metric screw is received in a respective one of the twelve chambers of the ratchet socket, so that the ratchet socket is combined with the metric screw.

15. The ratchet socket in accordance with claim 1, wherein the ratchet socket is used to operate a British screw.

16. The ratchet socket in accordance with claim 1, wherein the ratchet socket is used to operate a tetragonal screw.

17. The ratchet socket in accordance with claim 1, wherein the ratchet socket is used to operate an octagonal screw.

18. The ratchet socket in accordance with claim 1, wherein the ratchet socket is used to operate a dodecagonal screw.
